(19) United States
(12) Patent Application Publication
(10) Pub. No.: US 2026/0082017 A1
(43) Pub. Date: Mar. 19, 2026

(54) IMPROVED ISOLATION OF IN-ROOM PARTICIPANTS IN A VIRTUAL MEETING

(71) Applicant: Google LLC, Mountain View, CA (US)

(72) Inventor: Adam James Karnas, Del Mar, CA (US)

(21) Appl. No.: 18/888,809

(22) Filed: Sep. 18, 2024

(51) Int. Cl. H04N 7/15

(52) U.S. Cl. CPC H04N 7/152; H04N 7/157

(57) ABSTRACT

Systems and methods for to improved isolation of in-room participants in a virtual meeting. A video stream comprising a plurality of images of a plurality of participants of a virtual meeting is received. The video stream is split into a plurality of screen tiles. A first screen tile that depicts multiple participants is identified in the plurality of screen tiles. The first screen tile is associated with a first participant and includes a first image of the first participant and a second image of a second participant The first screen tile is caused to be modified to no longer depict the second image of the second participant. The plurality of screen tiles including the modified first screen tile is caused to be presented in a virtual meeting user interface.

### TECHNICAL FIELD

Aspects and implementations of the present disclosure relate to improved isolation of in-room participants in a virtual meeting.

### BACKGROUND

A platform can enable users to connect with other users through a video or an audio-based virtual meeting (e.g., a conference call, or a video conference). The platform can provide tools that allow multiple client devices to connect over a network and share each other's audio data (e.g., a voice of a user recorded via a microphone of a client device) and/or video data (e.g., a video captured by a camera of a client device, or video captured from a screen image of the client device) for efficient communication. In some instances, multiple client devices can capture video and/or audio data for a user, or a group of users (e.g., in the same meeting room), during a meeting. The video and/or audio can then be displayed in a user interface of the participating client devices. For example, the platform can display video from each client device in a separate box (commonly referred to as a tile) in the user interface.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for to improved isolation of in-room participants in a virtual meeting. A video stream comprising a plurality of images of a plurality of participants of a virtual meeting is received. Each screen tile is associated with one of the plurality of participants of the virtual meeting and comprises one or more images of one or more respective participants of the virtual meeting. The video stream is split into a plurality of screen tiles. A first screen tile that depicts multiple participants is identified in the plurality of screen tiles. The first screen tile is associated with a first participant and includes a first image of the first participant and a second image of a second participant The first screen tile is caused to be modified to no longer depict the second image of the second participant. The plurality of screen tiles including the modified first screen tile is caused to be presented in a virtual meeting user interface.

In some implementations, the video stream is generated by a hardware device of a meeting room. The plurality of participants is present in the meeting room during at least a portion of the virtual meeting. One or more additional participants remotely attend the virtual meeting.

In some implementations, each screen tile represents a sequence of cropped video frames of the video stream of a particular participant.

In some implementations, a plurality of images of respective participants of the virtual meeting is identified in a sequence of video frames comprised by the video stream and each screen tile of the plurality of screen tiles is produced by cropping the sequence of video frames to include at least one image of a participant of the virtual meeting.

In some implementations, the second participant is associated with a second screen tile and is depicted in the first screen tile and the second screen tile.

In some implementations, the second image of the second participant is removed from the area of the first screen tile and the area is filled using an artificial intelligence (AI) model. The AI model includes a diffusion model.

In some implementations, a visual effect is applied on the second image of the second participant. The visual effect obfuscates the second image of the second participant.

In some implementations, prior to causing the first screen tile to be modified to no longer depict the second image of the second participant ensuring that the plurality of screen tiles comprises a second screen tile that is associated with the second participant and depicts the second participant.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for using artificial intelligence (AI) to improve isolation of in-room participants in a virtual meeting, in accordance with some implementations of the present disclosure.

FIG. 2A illustrates an example video stream of the in-room participants, in accordance with some implementations of the present disclosure.

FIG. 2B illustrates example screen tiles of the in-room participants of FIG. 2A, in accordance with some implementations of the present disclosure.

FIG. 3A depicts using AI to remove other in-room participants from a screen tile of an in-room participant of the video stream of FIG. 2A, in accordance with implementations of the present disclosure.

FIG. 3B depicts using AI to reduce visual clarity of other in-room participants from a screen tile of an in-room participant of the video stream of FIG. 2A, in accordance with implementations of the present disclosure.

FIG. 3C depicts using AI to reduce visual clarity of other in-room participants from a screen tile of an in-room participant of the video stream of FIG. 2A, in accordance with implementations of the present disclosure.

FIG. 4 depicts a flow diagram of a method for using AI to improve isolation of in-room participants in a virtual meeting, in accordance with some implementations of the present disclosure.

FIG. 5 is a block diagram illustrating an example computer system, in accordance with some implementations of the present disclosure.

### DETAILED DESCRIPTION

Aspects of the present disclosure relate to using artificial intelligence (AI) to improve isolation of in-room participants in a virtual meeting. When in-room participants join a meeting from a physical location (e.g., a conference room), the in-room participants may collectively appear within a single screen tile. This collective display can make it challenging for remote participants to identify who is speaking or reacting at any given moment, leading to potential confusion and a less engaging experience. Isolating in-room participants in the video stream can significantly enhance the experience for both in-room and remote participants. By creating distinct screen tiles for each in-room participant (e.g., an in-room participant of interest), visibility, communication, and collaboration is improved, ensuring that remote participants can clearly see and identify who is speaking or reacting at any given moment.

However, this isolation presents certain challenges. One subject challenge is that in-room participants may be physically close to each other, making it difficult to isolate them in separate screen tiles without capturing parts of adjacent in-room participants (e.g., extra in-room participants). As a result, some distinct screen tiles may unintentionally include images of multiple in-room participants, leading to a cluttered and less focused viewing experience for remote participants.

To address this, the platform may attempt to decrease the size of the area centered around (or zoom into) each in-room participant. By narrowing the focus, the platform aims to exclude adjacent in-room participants (or parts of adjacent in-room participants) from the distinct screen tile. However, decreasing the size of the area centered around (or zooming into) each in-room participant can result in a reduced field of view. This reduction can make the images in the screen tile appear more constrained and less natural, potentially impacting the overall engagement and comfort of the remote participants. In-room participants may feel uncomfortable with the closeness of the field of view, while remote participants might find it harder to follow the dynamic interactions in the physical location due to the limited visibility of contextual cues, such as gestures or body language.

Aspects of the present disclosure address the above and other deficiencies by associating each screen tile with the primary image of an in-room participant (“participant of interest”), detecting the presences of images of extra in-room participants in a screen tile of an in-room participant of interest, and removing the images of the extra in-room participants from the distinct screen tile of the in-room participant of interest. In some implementations, before removing the image of an extra in-room participant from the screen tile, the virtual meeting platform may check to ensure that the participant whose image is being removed is associated as a participant of interest with another screen tile. In some implementations, an artificial intelligence (AI) model is used to fill the area associated with the removed images of extra in-room participants. In some implementations, a visual effects may be applied to the images of extra in-room participants to reduce visual clarity of the images of the extra in-room participants.

As described above, a video stream of the virtual meeting may include a plurality of frames (e.g., images) of multiple in-room participants located in a physical room. Each frame of the video stream can be split into a multiple screen tiles. Each screen tile can be associated with an in-room participant of the multiple in-room participants. In other words, in each frame, each in-room participant is detected and isolated from a respective frame. Isolating, as described above, may involve extracting a portion of (e.g., by cropping) the frame, such that the portion would include an in-room participant of interest. In some instances, in-room participants other than the in-room participant of interest (“extra in-room participant(s)”) may be present in the screen tile.

In some implementations, images of the extra in-room participant(s) can be removed from the screen tile for an in-room participant of interest. The AI model can be used to fill the area left from removing the extra in-room participant(s) (“area of interest”). More specifically, the AI model can draw a mask around the area of interest (i.e., generates a mask region). The AI model can capture essential features and patterns from the unmasked regions (i.e., regions other than the masked region) to characterize the context around the masked region. The AI model can then generate the missing parts of the screen tile, by filling in the masked region with content that matches the surrounding area (i.e., the unmasked regions). The resulting screen tile without the images of extra in-room participant(s) and with reconstructed image data matching the surrounding area can be visually rendered on a client device connected to the virtual meeting.

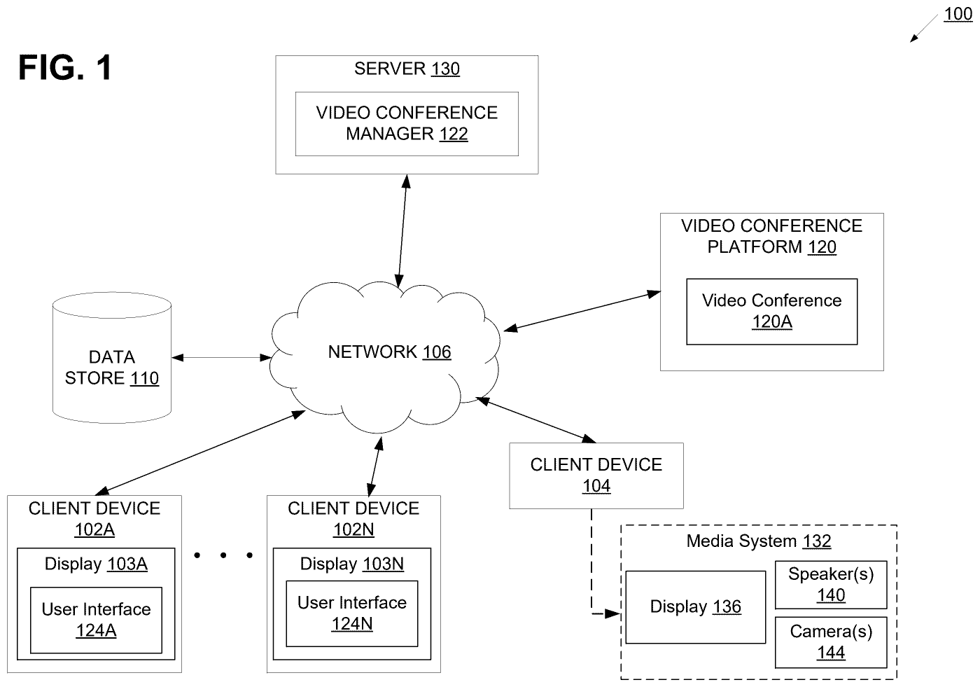

FIG. 1 illustrates an example system architecture 100, in accordance with implementations of the present disclosure. The system architecture 100 (also referred to as “system” herein) includes client devices 102A-N, one or more client devices 104, a data store 110, a video conference platform 120, and/or a server 130, each connected to a network 106.

In implementations, network 106 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data item can include audio data and/or video stream data, in accordance with implementations described herein. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by video conference platform 120 or one or more different machines (e.g., the server 130) coupled to the video conference platform 120 via network 106. In some implementations, the data store 110 can store portions of audio and video streams received from the client devices 102A-N for the video conference platform 120. Moreover, the data store 110 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents may be shared with users of the client devices 102A-N and/or concurrently editable by the users.

Video conference platform 120 can enable users of client devices 102A-N and/or client device(s) 104 to connect with each other via a video conference (e.g., a video conference 120A). A video conference refers to a real-time communication session such as a video conference call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Video conference platform 120 can allow a user to join and participate in a video conference call with other users of the platform. Implementations of the present disclosure can be implemented with any number of participants connecting via the video conference (e.g., from two participants up to one hundred or more).

The client devices 102A-N can each include computing devices such as personal computers (PCs), laptops, mobile phones, smart phones, tablet computers, netbook computers, network-connected televisions, etc. In some implementations, client devices 102A-N can also be referred to as “user devices.” Each client device 102A-N can include an audiovisual component that can generate audio and video data to be streamed to video conference platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component can also include an image capture device (e.g., a camera) to capture images and generate video data (e.g., a video stream) of the captured data of the captured images.

In some implementations, video conference platform 120 is coupled, via network 106, with one or more client devices 104 that are each associated with a physical conference or meeting room. Client device(s) 104 may include or be coupled to a media system 132 that may comprise one or more display devices 136, one or more speakers 140 and one or more cameras 144. Display device 136 can be, for example, a smart display or a non-smart display (e.g., a display that is not itself configured to connect to network 106). Users that are physically present in the room (e.g., in-room users) can use media system 132 rather than their own devices (e.g., client devices 102A-N) to participate in a video conference, which may include other remote users. For example, the users in the room that participate in the video conference may control the display 136 to show a slide presentation or watch slide presentations of other participants. Sound and/or camera control can similarly be performed. Similar to client devices 102A-N, client device(s) 104 can generate audio and video data to be streamed to video conference platform 120 (e.g., using one or more microphones, speakers 140 and cameras 144).

Each client device 102A-N or 104 can include a web browser and/or a client application (e.g., a mobile application, a desktop application, etc.). In some implementations, the web browser and/or the client application can present, on a display device 103A-103N of client device 102A-N, a user interface (UI) (e.g., a UI of the UIs 124A-N) for users to access video conference platform 120. For example, a user of client device 102A can join and participate in a video conference via a UI 124A presented on the display device 103A by the web browser or client application. A user can also present a document to participants of the video conference via each of the UIs 124A-N. Each of the UIs 124A-N can include multiple visual items corresponding to video streams of the client devices 102A-N provided to the server 130 for the video conference. A visual item can refer to a UI element that occupies a particular region in the UI and is dedicated to presenting a video stream from a respective client device. Such a video stream can depict, for example, a user of the respective client device while the user is participating in the video conference (e.g., speaking, presenting, listening to other participants, watching other participants, etc., at particular moments during the video conference), a physical conference or meeting room (e.g., with one or more participants present), a document or media content (e.g., video content, one or more images, etc.) being presented during the video conference, etc.

An audiovisual component of each client device can capture images and generate video data (e.g., a video stream) of the captured data of the captured images. The audiovisual component of each client device can also capture an audio signal representing speech of a user and generate audio data (e.g., an audio file or audio stream) based on the captured audio signal. In some implementations, the client devices 102A-N, 104 can transmit the generated video stream and/or audio stream directly to other client devices 102A-N, 104 participating in the video conference. In some implementations, the client devices 102A-N and/or client device(s) 104 can transmit the generated video stream and/or audio stream to a video conference manager 122. In some implementations, the client devices 102A-N, 104 participating in the video conference can transmit video streams (including audio data) to server 130 which includes the video conference manager 122. The server 130 can execute the video conference manager 122.

The video conference manager 122 receives a video stream from each client device. For example, a video stream generated by client device 104 may include multiple users physically present in a specific location. The video conference manager 122 analyzes each frame of the video stream using various detection techniques to identify each participant in the frame. These detection techniques include, for example, Haar cascades, histogram of oriented gradients, or machine learning.

The video conference manager 122 identifies and extracts a set of current facial landmarks from each detected image of a participant. These facial landmarks are specific, predefined points on a face that represent key anatomical features and are used to map facial geometry and structure. The set of current facial landmarks allows continuous monitoring of facial movements and positions across frames of the video stream by providing key reference points. Using these landmarks, the video conference manager 122 follows the location of each participant's image across subsequent frames of the video stream. This monitoring can be performed using various algorithms, such as Kanade-Lucas-Tomasi (KLT), Minimum Output Sum of Squared Error (MOSSE), or machine learning.

The video conference manager 122 divides each frame of the video stream into multiple screen tiles. Each screen tile is generated by cropping a section of the frame centered around the detected image of a participant associated with a respective screen tile. The video conference manager 122 assigns a unique tile identifier to each detected image of a participant and its corresponding screen tile. This tile identifier, which may be an alphanumeric value, ensures that each screen tile is linked to the specific participant it was generated for (e.g., subject participant). Accordingly, the video conference manager 122 can distinguish between the subject participant associated with a screen tile and any other participants who may appear in the screen tile (e.g., extra participant(s)).

The video conference manager 122 determines, for each screen tile, whether a respective screen tile includes an image of one or more extra participant(s). The video conference manager 122 compares a tile identifier of a respective screen tile to a tile identifier of each detected image of a participant present in the respective screen tile. The tile identifier of a detected image of the participant that is present in the respective screen tile which matches the tile identifier of the respective screen tile is identified as a subject participant for the respective tile. Tile identifiers of other detected images of participants that is present in the respective screen tile which does not match the tile identifier of the respective screen tile is identified as extra participant(s).

In some implementations, the video conference manager 122 may apply a visual effect to the detected images of the extra participant(s). The visual effect may be, for example, a blur effect (e.g., Gaussian blur). Thus, the video conference manager 122 modifies the visual clarity of the extra participant(s) in the respective screen tile.

In some implementations, the video conference manager 122 may remove the detected images of the extra participant(s) from a respective screen tile. The video conference manager 122 may include an AI inference system 124. The AI inference system 124 may include one or more AI models configured to modify the respective screen tile to fill the screen tile after the detected images of the extra participant(s) are removed from the respective screen tile. For example, once the detected images of the extra participant(s) are removed, the AI inference system 124 draws a mask around a blank area of the respective screen tile (i.e., an area where the detected images of the extra participant(s) were removed from) to generate a mask region. The AI inference system 124 captures features and patterns from unmasked regions of the respective screen tile (i.e., regions of the respective screen tile other than the masked region). The AI inference system 124 generates pixels, matching the surrounding area, to be replaced with the masked region. The AI inference system 124 replaces the masked region with the generated pixels. Thus, the video conference manager 122 fills the blank area with image data such that the area is not blank and blends into portions of the respective screen tile.

In one implementation, the AI model may include one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron may be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, the AI model may include a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, the AI model can be an AI model that has been trained on a corpus of data. In some implementations, the AI model can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model to learn broad elements including, image or speech recognition, general sentence structure, common phrases, vocabulary, natural language structure, and other elements. In some implementations, this first, foundational model can be trained using self-supervision, or unsupervised training on such datasets.

In some implementations, the second portion of training, including fine-tuning, may be unsupervised, supervised, reinforced, or any other type of training. In some implementations, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model while a user may rank training, according to a variety of factors, including accuracy, helpfulness, veracity, acceptability, or any other metric useful in the fine-tuning portion of training. In this manner, the AI model can learn to favor these and any other factors relevant to users when generating a response. Further details regarding training are provided below.

In some implementations, the AI model may include one or more pre-trained models, or fine-tuned models. In a non-limiting example, in some implementations, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

As indicated above, the AI model may be one or more generative AI models, allowing for the generation of new and original content. The generative AI model can use other machine learning models including an encoder-decoder architecture including one or more self-attention mechanisms, and one or more feed-forward mechanisms. In one implementation, the generative AI model may include a diffusion model. A diffusion model may include a deep generative model that can be used to generate images, edit existing images, and create new image styles. The diffusion model may have been trained by iteratively applying a diffusion process to an input image, which may include gradually adding noise to the image until it becomes unrecognizable. The diffusion model then learns to reverse this process, starting from the noisy image and gradually denoising it until it becomes a recognizable image. In some implementation, the diffusion model may have been trained on multiple virtual meeting backgrounds by using different virtual meeting backgrounds as input images during the training process.

In some implementations, video conference platform 120 and/or server 130 can be one or more computing devices computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a video conference. Video conference platform 120 may also include a website (e.g., a webpage) or application back-end software that may be used to enable a user to connect with other users via the video conference.

It should be noted that in some other implementations, the functions of server 130 or video conference platform 120 may be provided by a fewer number of machines. For example, in some implementations, server 130 may be integrated into a single machine, while in other implementations, server 130 may be integrated into multiple machines. In addition, in some implementations, server 130 may be integrated into video conference platform 120.

In general, functions described in implementations as being performed by video conference platform 120 or server 130 can also be performed by the client devices 102A-N and/or client device(s) 104 in other implementations, if appropriate. In addition, the functionality attributed to a particular component can be performed by different or multiple components operating together. Video conference platform 120 and/or server 130 can also be accessed as a service provided to other systems or devices through appropriate application programming interfaces, and thus is not limited to use in websites.

Although implementations of the disclosure are discussed in terms of video conference platform 120 and users of video conference platform 120 participating in a video conference, implementations may also be generally applied to any type of telephone call or conference call between users. Implementations of the disclosure are not limited to video conference platforms that provide video conference tools to users.

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user.” In another example, an automated consumer may be an automated ingestion pipeline, such as a topic channel, of the video conference platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

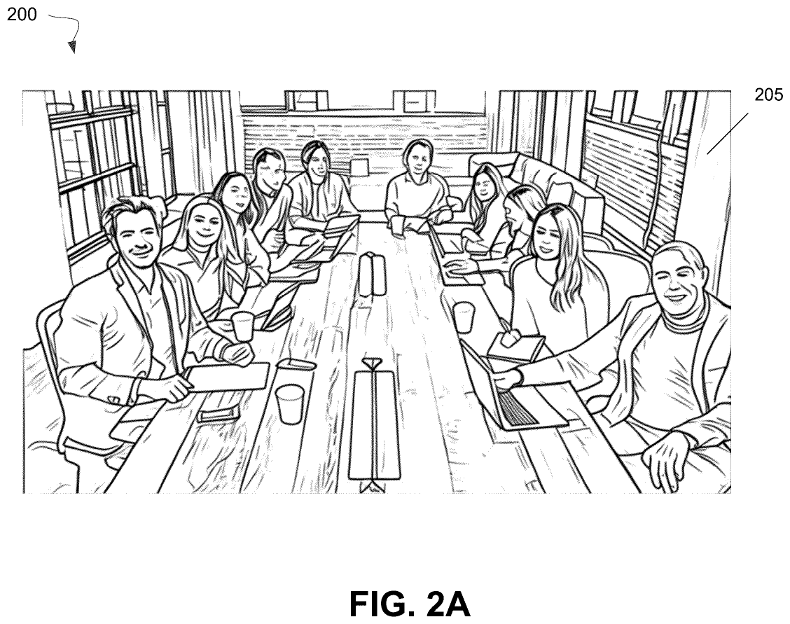

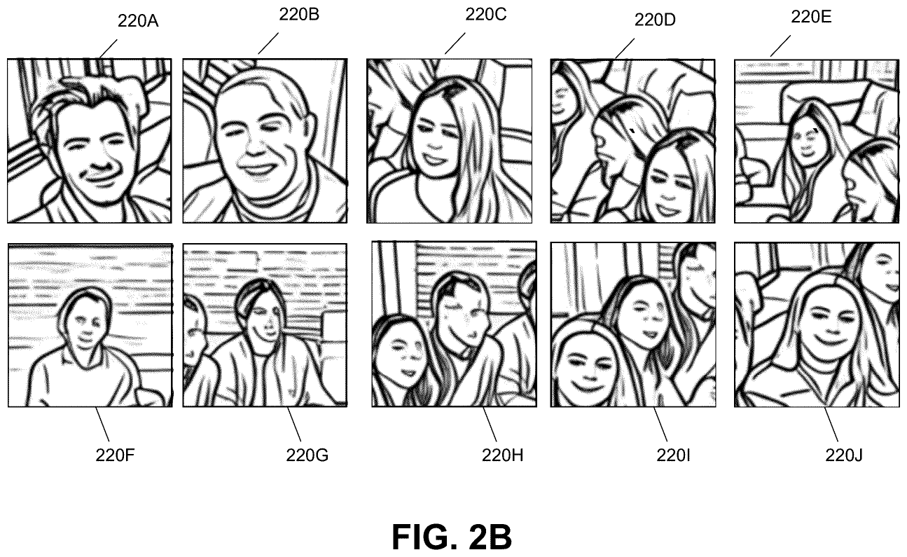

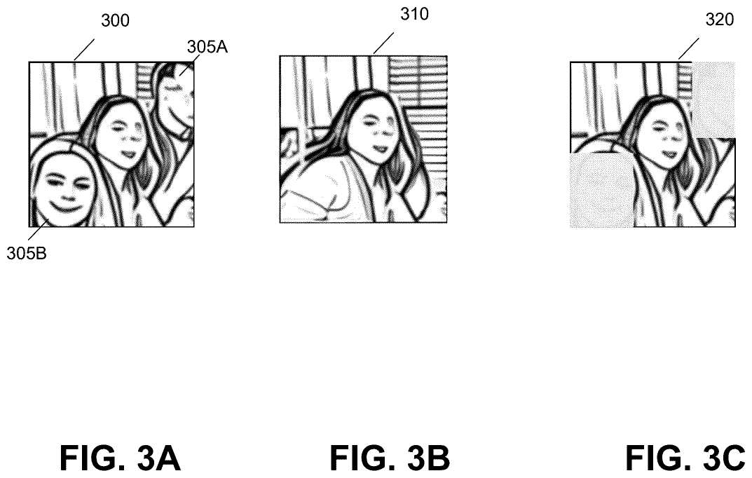

FIG. 2A illustrates an example frame 200 of a video stream, in accordance with some implementation of the present disclosure. As previously described, client device 104 is associated with a physical location (e.g., room 205). The video conference manager 122 of FIG. 1 detects one or more images of participants in the frame 200. The video conference manager 122 splits, based on detected images of participants, frame 200 into a plurality of screen tiles (e.g., screen tiles 220A-J of FIG. 2B). With quick reference to FIG. 3A, the video conference manager 122 of FIG. 1 identifies images of extra participant(s) 305A and 305B in a screen tile 300 (e.g., screen tile 220I of FIG. 2B). With reference to FIG. 3B, in some implementations, the video conference manager 122 of FIG. 1 generates, using the AI inference system 124 of FIG. 1, screen tile 310 which removes the images of the extra participants 305A and 305B from screen tile 300 of FIG. 3A. With reference to FIG. 3C, in other implementations, the video conference manager 122 of FIG. 1 applies a visual effect on the images of the extra participants 305A and 305B in the screen tile 300 of FIG. 3A to generate screen tile 320.

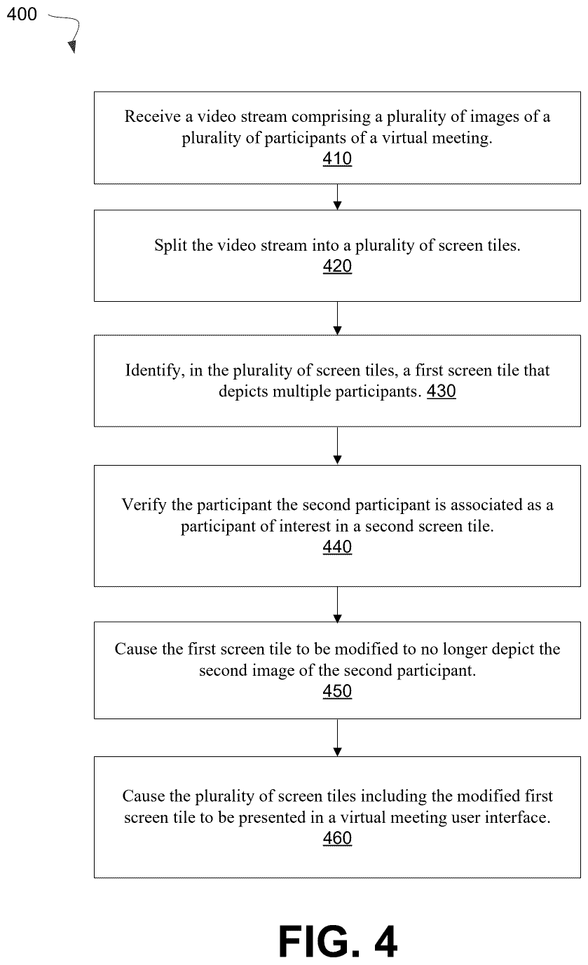

FIG. 4 is a flowchart illustrating one implementation of a method 400 for to improved isolation of in-room participants in a virtual meeting, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 400 and/or one or more of the method's 400 individual functions, routines, subroutines, or operations. In certain implementations, a single processing thread can perform the method 400. Alternatively, two or more processing threads can perform the method 400, each thread executing one or more individual functions, routines, subroutines, or operations of the method. In an illustrative example, the processing threads implementing the method 400 can be synchronized (e.g., using semaphores, critical sections, and/or other thread synchronization mechanisms). Alternatively, the processing threads implementing the method 400 can be executed asynchronously with respect to each other. Various operations of the method 400 can be performed in a different (e.g., reversed) order. Some operations of the method 400 can be performed concurrently with other operations. Some operations can be optional. In some implementations, the video conference manager 122 performs one or more of the operations of the method 400.

At block 410, the processing logic receives a video stream comprising a plurality of images of a plurality of participants of a virtual meeting. The video stream may be generated by a hardware device of a meeting room. The plurality of participants may be present in the meeting room during at least a portion of the virtual meeting. One or more additional participants may remotely attend the virtual meeting.

At block 420, the processing logic splits the video stream into a plurality of screen tiles. Each frame of the video stream can be split into a multiple screen tiles. Each screen tile can be associated with an in-room participant of the multiple in-room participants. In particular, a portion of each frame is cropped such that the portion includes an image of an in-room participant associated with a respective screen tile. In some instances, images of in-room participants other than the image of the in-room participant of interest (“extra in-room participant(s)”) may be present in the respective screen tile.

At block 430, the processing logic identifies, in the plurality of screen tiles, a first screen tile that depicts multiple participants. In other words, the processing logic determines that the first screen tile is associated with a first participant. The processing logic then determines whether the first screen tile includes images of extra in-room participant(s). For example, the processing logic determines that the first screen time includes a second image of a second participant (e.g., an extra participant) (i.e., an image other than a first image of the first participant). The second participant may be associated with a second screen tile and is depicted in the first screen tile and the second screen tile.

At block 440, the processing logic verifies the participant the second participant is associated as a participant of interest in a second screen tile. In other words, before causing the first screen tile to be modified to no longer depict the second image of the second participant, the second participant must be associated with another screen tile (e.g., the second screen tile).

At block 450, the processing logic causes the first screen tile to be modified to no longer depict the second image of the second participant. In some embodiments, the processing logic modifies the screen tile by removing images of extra in-room participant(s). For example, the second image of the second participant (extra participant) is removed from within the first screen tile and filled using AI model (e.g., a diffusion model) or visual effects are applied to the second image of the second participant such that the second image of the second participant is obfuscated. At block 450, the processing logic causes the plurality of screen tiles including the modified first screen tile to be presented in a virtual meeting user interface.

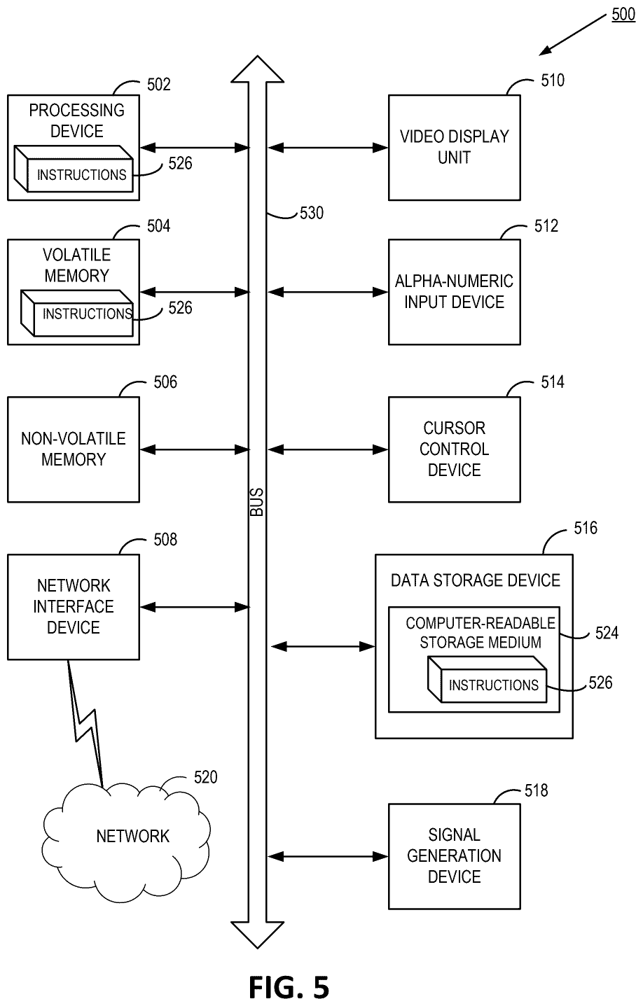

FIG. 5 is a block diagram illustrating an example computer system, in accordance with implementations of the present disclosure. The computer system 500 can include a client device 102, 104B-N, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 516, which communicate with each other via a bus 530.

The processing device 502 represents one or more general-purpose processing devices such as a microprocessor, central processing unit, or the like. More particularly, the processing device 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 can also be one or more special-purpose processing devices such as an application specific integrated circuit (ASIC), a field programmable gate array (FPGA), a digital signal processor (DSP), network processor, or the like. The processing device 502 is configured to execute the processing logic 522 for performing the operations discussed herein (e.g., the operations of the video conference manager 122).

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker).

The data storage device 516 can include a non-transitory machine-readable storage medium 524 (sometimes referred to as a “computer-readable storage medium”) on which is stored one or more sets of instructions 526 (e.g., the instructions to carry out one or more operations of the video conference manager 122) embodying any one or more of the methodologies or functions described herein. The instructions can also reside, completely or at least partially, within the main memory 504 and/or within the processing device 502 during execution thereof by the computer system 500, the main memory 504 and the processing device 502 also constituting machine-readable storage media. The instructions can further be transmitted or received over the network 150 via the network interface device 508.

In one implementation, the instructions 526 include instructions for performing the operations discussed herein (e.g., the operations of the video conference manager 122). While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, by a processing device, a video stream comprising a plurality of images of a plurality of participants of a virtual meeting;
splitting the video stream into a plurality of screen tiles, wherein each screen tile is associated with one of the plurality of participants of the virtual meeting and comprises one or more images of one or more respective participants of the virtual meeting;
identifying, in the plurality of screen tiles, a first screen tile that depicts multiple participants, wherein the first screen tile is associated with a first participant and includes a first image of the first participant and a second image of a second participant;
causing the first screen tile to be modified to no longer depict the second image of the second participant; and
causing the plurality of screen tiles including the modified first screen tile to be presented in a virtual meeting user interface.

2. The method of claim 1, wherein the video stream is generated by a hardware device of a meeting room, wherein the plurality of participants is present in the meeting room during at least a portion of the virtual meeting, and wherein one or more additional participants remotely attend the virtual meeting.

3. The method of claim 1, wherein each screen tile represents a sequence of cropped video frames of the video stream of a particular participant.

4. The method of claim 1, wherein spitting the video stream into the plurality of screen tiles further comprises:
identifying, in a sequence of video frames comprised by the video stream, a plurality of images of respective participants of the virtual meeting; and
producing each screen tile of the plurality of screen tiles by cropping the sequence of video frames to include at least one image of a participant of the virtual meeting.

5. The method of claim 1, wherein the second participant is associated with a second screen tile and is depicted in the first screen tile and the second screen tile.

6. The method of claim 1, wherein the second image of the second participant is depicted in an area of the first screen tile, and wherein causing the first screen tile to be modified to no longer depict the second image of the second participant comprises:
removing the second image of the second participant from the area of the first screen tile; and
using an artificial intelligence (AI) model to fill the area.

7. The method of claim 6, wherein the AI model comprises a diffusion model.

8. The method of claim 1, wherein causing the first screen tile to be modified to no longer depict the second image of the second participant comprises:
applying a visual effect on the second image of the second participant, wherein the visual effect obfuscates the second image of the second participant.

9. The method of claim 1, wherein prior to causing the first screen tile to be modified to no longer depict the second image of the second participant ensuring that the plurality of screen tiles comprises a second screen tile that is associated with the second participant and depicts the second participant.

10. A system comprising:
a memory device; and
a processing device coupled to the memory device, the processing device to perform operations comprising:
receiving a video stream comprising a plurality of images of a plurality of participants of a virtual meeting;
splitting the video stream into a plurality of screen tiles, wherein each screen tile is associated with one of the plurality of participants of the virtual meeting and comprises one or more images of one or more respective participants of the virtual meeting;
identifying, in the plurality of screen tiles, a first screen tile that depicts multiple participants, wherein the first screen tile is associated with a first participant and includes a first image of the first participant and a second image of a second participant;
causing the first screen tile to be modified to no longer depict the second image of the second participant; and
causing the plurality of screen tiles including the modified first screen tile to be presented in a virtual meeting user interface.

11. The system of claim 10, wherein the video stream is generated by a hardware device of a meeting room, wherein the plurality of participants is present in the meeting room during at least a portion of the virtual meeting, and wherein one or more additional participants remotely attend the virtual meeting.

12. The system of claim 10, wherein each screen tile represents a sequence of cropped video frames of the video stream of a particular participant.

13. The system of claim 10, wherein spitting the video stream into the plurality of screen tiles further comprises:
identifying, in a sequence of video frames comprised by the video stream, a plurality of images of respective participants of the virtual meeting; and
producing each screen tile of the plurality of screen tiles by cropping the sequence of video frames to include at least one image of a participant of the virtual meeting.

14. The system of claim 10, wherein the second participant is associated with a second screen tile and is depicted in the first screen tile and the second screen tile.

15. The system of claim 10, wherein the second image of the second participant is depicted in an area of the first screen tile, and wherein causing the first screen tile to be modified to no longer depict the second image of the second participant comprises:
removing the second image of the second participant from the area of the first screen tile; and
using an artificial intelligence (AI) model to fill the area.

16. The system of claim 10, wherein causing the first screen tile to be modified to no longer depict the second image of the second participant comprises:
applying a visual effect on the second image of the second participant, wherein the visual effect obfuscates the second image of the second participant.

17. The system of claim 10, wherein prior to causing the first screen tile to be modified to no longer depict the second image of the second participant ensuring that the plurality of screen tiles comprises a second screen tile that is associated with the second participant and depicts the second participant.

18. A non-transitory machine-readable storage medium storing instructions which, when executed, cause a processing device to perform operations comprising:
receiving, by a processing device, a video stream comprising a plurality of images of a plurality of participants of a virtual meeting;
splitting the video stream into a plurality of screen tiles, wherein each screen tile is associated with one of the plurality of participants of the virtual meeting and comprises one or more images of one or more respective participants of the virtual meeting;
identifying, in the plurality of screen tiles, a first screen tile that depicts multiple participants, wherein the first screen tile is associated with a first participant and includes a first image of the first participant and a second image of a second participant;
causing the first screen tile to be modified to no longer depict the second image of the second participant; and
causing the plurality of screen tiles including the modified first screen tile to be presented in a virtual meeting user interface.

19. The non-transitory machine-readable storage medium of claim 18, wherein the second image of the second participant is depicted in an area of the first screen tile, and wherein causing the first screen tile to be modified to no longer depict the second image of the second participant comprises:
removing the second image of the second participant from the area of the first screen tile; and
using an artificial intelligence (AI) model to fill the area.

20. The non-transitory machine-readable storage medium of claim 18, wherein causing the first screen tile to be modified to no longer depict the second image of the second participant comprises:
applying a visual effect on the second image of the second participant, wherein the visual effect obfuscates the second image of the second participant.
